(19) United States
(12) Patent Application Publication
(10) Pub. No.: US 2012/0095873 A1
(43) Pub. Date: Apr. 19, 2012

(54) ESCROW MANAGEMENT SYSTEM FOR MARKETPLACES

(75) Inventors: Sanjay Narang, Foster City, CA (US); Claudia H. Liu, San Jose, CA (US); Sharad Sharma, Santa Clara, CA (US); Zonghong Zhang, Shanghai (CN)

(73) Assignee: eBay Inc., San Jose, CA (US)

(21) Appl. No.: 13/207,116

(22) Filed: Aug. 10, 2011

Related U.S. Application Data
(60) Provisional application No. 61/393,110, filed on Oct. 14, 2010.

(51) Int. Cl. G06Q 30/00

(52) U.S. Cl. 705/26.41

(57) ABSTRACT

An escrow management system is described. Transaction information between the seller and the buyer from the online marketplace application is received. A shipping transaction information associated with the transaction of a shipping vendor of the marketplace is received. The transaction information and the shipping transaction information are communicated to a financial journaling system. A balance manager module provides collection and payment for the transaction and the shipping transaction in real time, provides a real time journal of the transaction and the shipping transaction, and synchronizes with the financial journaling system without having to manually reconcile with the online market application and the shipping vendor. The balance manager module provides an integrated system to track cash flows related to the collection and payment corresponding to the transaction and shipping transaction.

### RELATED APPLICATION

The present application claims priority from U.S. Provisional Patent Application Ser. No. 61/393,110, filed Oct. 14, 2011, which is incorporated herein by reference in its entirety.

### TECHNICAL FIELD

This application relates generally to the field of computer technology, and in a specific example embodiment, a method and system for financial transaction, processing management and reconciliation with different payment processors and client applications.

### BACKGROUND

Prior art systems allow for batch processing of collections and payment. In situations where, for example, a chargeback is needed, details of an individual transaction may not be available or must be pulled from all systems involved, whereby reconciliation between these systems must be performed.

### BRIEF DESCRIPTION OF THE DRAWINGS

The present invention is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram illustrating an example embodiment of a logic flow illustrating an operation of an escrow management system;

FIG. 3 is a block diagram illustrating an example embodiment of an escrow management module;

FIG. 4 is a block diagram illustrating an example embodiment of a balance manager module;

FIG. 5 is a block diagram illustrating an example embodiment of a process flow of a seller shipping payment;

FIG. 6 is a block diagram illustrating an example embodiment of a process flow for a financial reconciliation;

FIG. 7 is a block diagram illustrating an example embodiment of a transaction status transition diagram;

FIG. 8 is a flow diagram illustrating an example embodiment of a process for tracking payment between payer and payee;

FIG. 9 is a flow chart of one embodiment of a method for an escrow management system;

FIG. 10 is a flow chart of another embodiment of a method for an escrow management system;

FIG. 11 shows a diagrammatic representation of machine in the example form of a computer system within which a set of instructions may be executed to cause the machine to perform any one or more of the methodologies discussed herein; and

FIG. 12 is a block diagram illustrating an example embodiment of a table of shipping label information stored in a shipping label database;

### DETAILED DESCRIPTION

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In various embodiments, a computerized escrow management system is described. An escrow management system has a client interface, a marketplace interface, a vendor interface, a journal interface, a balance manager module, and a payment gateway interface. The client interface communicates with a payer and payee application. The marketplace interface receives transaction information concerning a transaction between a seller and a buyer from the marketplace application for payment processing. The vendor interface communicates information concerning the payout/disbursement to the service provider/vendor. The journal interface communicates financial transaction information to a financial journaling system. The balance manager module operates to provide collection and payment functionality for the transaction and to facilitate a shipping transaction in real time. The balance manager module also provides a real time journal of the transaction and the shipping transaction. The balance manager module also synchronizes information with the financial journaling system thereby eliminating the need for an administrator to manually reconcile information with the market application and the shipping vendor. The payment gateway interface communicates payment information with a payment gateway. The payment gateway also communicates information with financial systems associated with the seller, and the shipping vendor, and settles the transaction and the shipping transaction with the financial journaling system as directed by the balance manager module.

The present escrow management system allows processing to be performed based on a transaction level. The collection and payment may be performed in real time. Additionally, there is a real time journal of each transaction that includes tracking and information for each transaction. The journal is automatically synchronized with a journaling system developed and sold by SAP America of Newton Square, Pa. Further, a built-in chargeback system removes the need to have to reconcile different systems. Automated exceptions are built into the system.

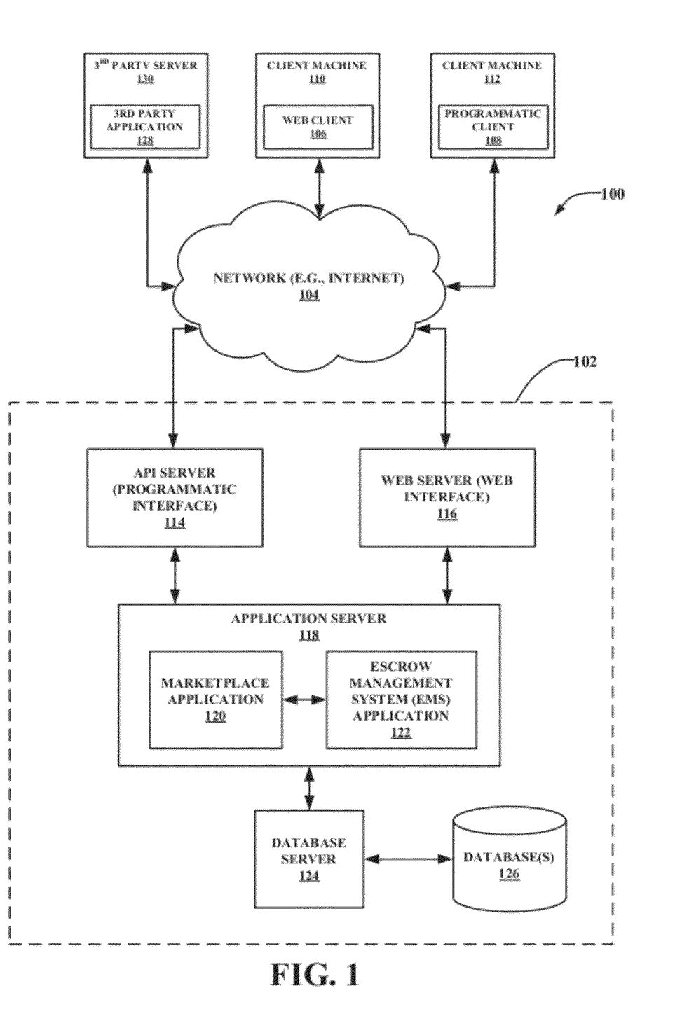

FIG. 1 is a network diagram depicting a network system 100, according to one embodiment, having a client-server architecture configured for exchanging data over a network. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as a peer-to-peer or distributed network environment.

A data exchange platform, in an example form of a marketplace application 120 and an escrow management system (EMS) application 122, may provide server-side functionality, via a network 104 (e.g., the Internet) to one or more clients. The one or more clients may include users that utilize the network system 100 and more specifically, the marketplace application 120 and the EMS application 122, to exchange data over the network 104. These transactions may include transmitting, receiving (communicating) and processing data to, from, and regarding content and users of the network system 100. The data may include, but are not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data such as collection and payment, shipping transactions, shipping label purchases, and real time synchronization of financial journals, among other things.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments the client machines 110, 112, or 3^{rd} party server 130 may be associated with a buyer, a seller, a third party electronic commerce platform, a payment service provider, a shipping service provider, a financial institution system, each in communication with the network-based based publisher 102 and optionally each other. The buyers and sellers may be any one of individuals, merchants, or service providers, among other things.

Turning specifically to the marketplace application 120 and the EMS application 122, an application program interface (API) server 114 and a web server 116 are coupled to, and provide programmatic and web interfaces respectively to, one or more application servers 118. The application server 118 hosts one or marketplace applications 120 and the EMS application 122. The application server 118 is, in turn, shown to be coupled to one or more database servers 124 that facilitate access to one or more database(s) 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or 3^{rd} party server 130).

In one embodiment, the marketplace application 120 provides listings and price-setting mechanisms whereby a user may be a seller or buyer who lists or buys goods and/or services (e.g., for sale) published on the marketplace application 120. The EMS application 122 may provide a number of transaction functions and services (e.g., collection, payment, refunds, etc.) to users that access the marketplace application 120.

The EMS application 122 provides the ability to:
Maintain audit history and information at the individual transaction level
Track status of a transaction from end-to-end, by updating the transaction's status
Enable funds collection from one or multiple payees
Enable automatic funds payment to one or multiple payers
Provide a sub-ledger function for financial transactions
Automate journals containing financial general ledger accounts and amount information to SAP
Perform reconciliation between EMS-recorded transactions to external vendor source systems.

Some of the functionality of the EMS includes:
Track daily payments and transaction-breakdowns between payees and payers
Integrate with payment gateway to perform real time payment authorization check for user-fund availability
Update transaction “status” to reflect current situation of payment/collection
Support status changes resulting from activities (e.g. payments, adjustments, refunds, write-offs, reversals, vendor payout)
Automate daily vendor payout based on pre-set threshold checks
Automate refund payments upon notice of refund approval
Configurable dollar-threshold to provide control, compliance and monitoring for vendor payments
Trigger the recording of financial activity at specific transaction status changes
Aggregate financial transactions daily and monthly for journals
Interface to SAP to post summarized financial activity to general ledger
Maintain history of journal transactions and act as transaction sub-ledger
Perform transaction matching to track cash reconciliation
Reconcile transaction details to vendor source records for transaction validation
Identify mismatched transactions/amounts and other exceptions.

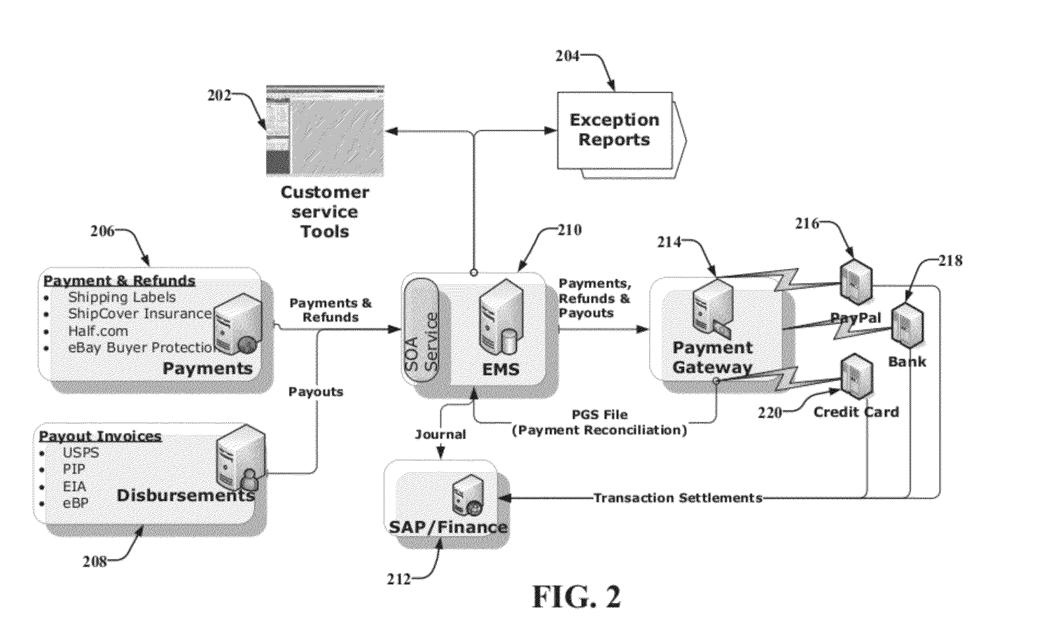

FIG. 2 is a block diagram illustrating an example embodiment of a logic flow illustrating an operation of an EMS 210. The EMS 210 receives transaction data, including payments and refunds, from a payment system 206. In one embodiment, the payment system 206 handles, for example, payments and refunds for shipping labels, shipping insurance, and buyer protection plans, among others. The payment system 206 includes for example, one or more servers to operate the payments and refunds. In another embodiment, the payment system 206 communicates with the marketplace application 120 of FIG. 1.

The EMS 210 communicates with a disbursement system 208 that handles payout invoices (e.g. United States Postal Office and other shipping vendors). In one embodiment, the disbursement system 208 includes one or more servers communicating with servers from the shipping vendors.

The EMS 210 communicates the payments, refunds and payouts to a payment gateway 214 that communicates the financial transaction with the respective financial systems (e.g. PayPal 216, bank system 218, and credit card system 220). In one embodiment, the payment gateway 214 communicates with one or more financial systems associated with the buyer and the seller and reconciles financial transactions with the EMS 210.

Financial transactions from the respective financial systems 216, 218, and 220 are settled in a financial journaling system such as SAP/Finance system 212. In one embodiment, the EMS 210 synchronizes its journal in real time with the SAP/Finance 212 without the need to reconcile with the different financial systems. In another embodiment, the payment gateway 214 returns a payment reconciliation file to the EMS 210.

In one embodiment, the EMS 210 provides a customer service tool 202 for tracking the transactions. In another embodiment, the EMS 210 is capable of generating exception reports 204 when exceptions from the financial transaction arise. The EMS 210 generates the exception reports 204.

In one embodiment, the transaction comprises a buyer protection insurance purchase, and the shipping transaction comprises a shipping label purchase or a shipping insurance purchase.

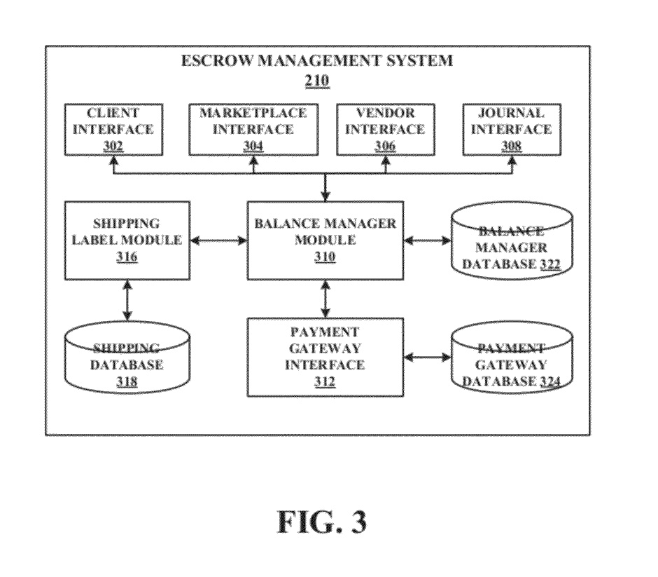

FIG. 3 is a block diagram illustrating an example embodiment of the EMS 210. The EMS 210 includes a balance manager module 310 that communicates with a client interface 302, a marketplace interface 304, a vendor interface 306, and a journal interface 308. The client interface 302 communicates with a client (a seller and a buyer) of the marketplace application 120. The marketplace interface 304 receives a transaction between the seller and the buyer from the marketplace application 120. The vendor interface 306 receives a shipping transaction associated with the transaction of a shipping vendor of the marketplace application 120. The journal interface 308 communicates the transaction and the shipping transaction to a financial journaling system (e.g. SAP 212). In one embodiment these interfaces 302, 304, 306, and 308 may be in the form of an API.

In one embodiment, the balance manager module 310 provides collection and payment for the transaction and the shipping transaction in real time. The balance manager module 310 also provides a real time journal of the transaction and the shipping transaction and synchronizes with the financial journaling system without having to manually reconcile with the market application and the shipping vendor.

The escrow management system also includes a payment gateway interface 312 that communicates with payment gateway 214. The payment gateway 214 communicates with financial systems associated with the seller, and the shipping vendor and settles the transaction and the shipping transaction with the financial journaling system 212 as directed by the balance manager module 310.

A shipping label module 316 provides a shipping label for the shipping transaction based on a status of the shipping transaction based on the real time journal of the shipping transaction from the balance manager module 310. The shipping label is received at the vendor interface 306 from the shipping vendor. The shipping label module 316 voids the shipping label for the shipping transaction when the status of the shipping transaction includes a failed payment for the shipping label.

A shipping storage device 318 (e.g., a database) is coupled to the shipping label module 316. The shipping storage device 318 stores shipping label information.

A balance manager storage device 322 (e.g., a database) is coupled to the balance manager module. The balance manager storage device 322 stores the real time journal of the transaction and the shipping transaction.

A payment gateway storage device 324 (e.g., a database) is coupled to the payment gateway interface 312. The payment gateway storage device 324 stores a payment failure or a payment success for the transaction and the shipping transaction based on a communication with the payment gateway.

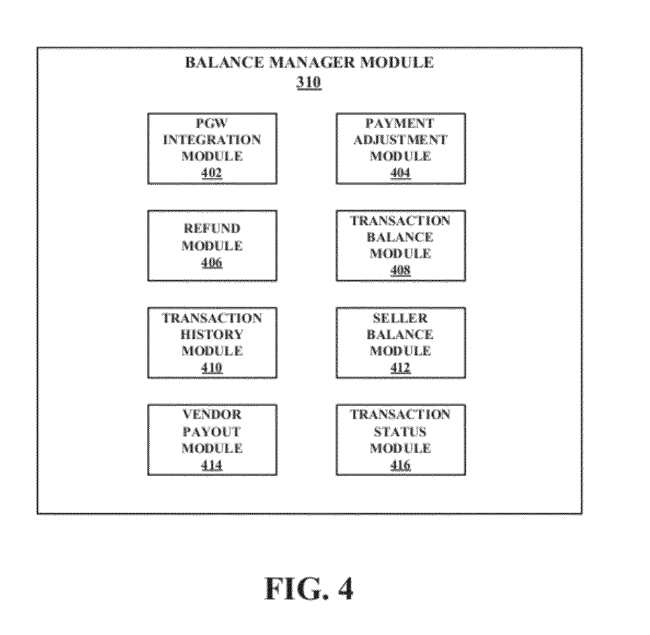

FIG. 4 is a block diagram illustrating an example embodiment of a balance manager module. The balance manager module 310 includes a payment gateway integration module 402, a payment adjustment module 404, a refund module 406, a transaction balance module 408, a transaction history module 410, a seller balance module 412, a vendor payout module 414, and a transaction status module 416.

The payment gateway integration module 402 communicates with the payment gateway interface 312 for a seller payment authorization, a refund shipping label credit to the seller, and a shipping vendor payout. The payment adjustment module 404 captures an adjustment to the payment associated with the transaction and the shipping transaction. The refund module 406 tracks refund payments as well as refund collections associated with the payment transaction and the shipping transaction. The transaction balance module 408 tracks a balance of the transaction and the shipping transaction. The transaction history module 410 tracks a history of journal transactions. The seller balance module 412 tracks a balance of the seller. The vendor payout module 414 supports a vendor payout. The transaction status module 416 supports transaction status comprising a payment, an adjustment, a refund, and a vendor payout.

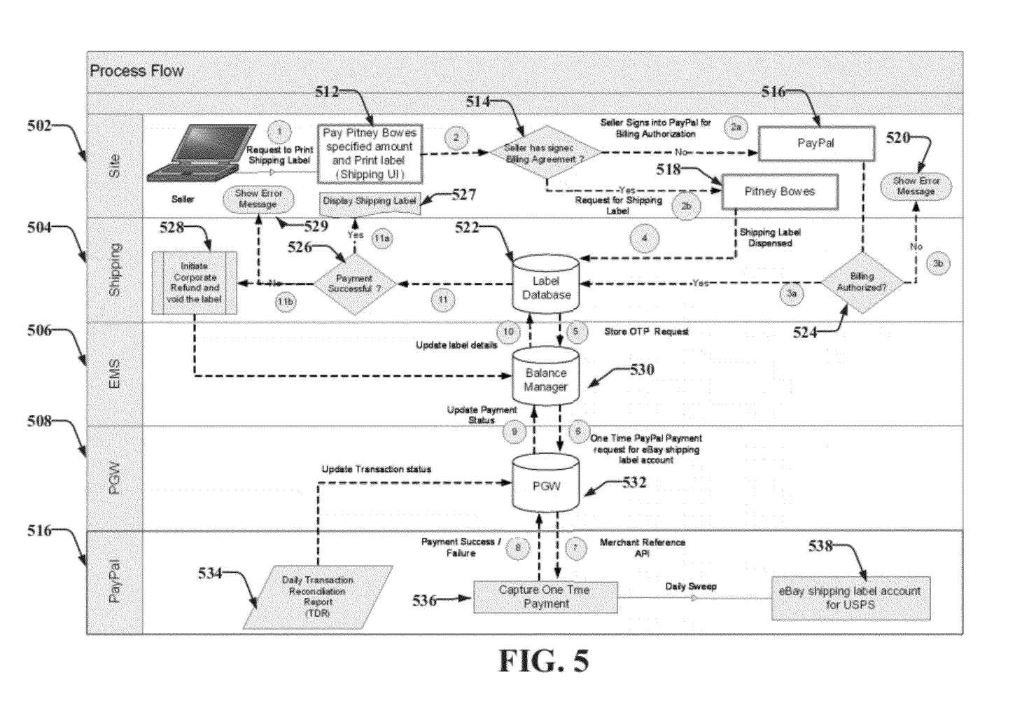

FIG. 5 is a block diagram illustrating an example embodiment of a process flow of a seller shipping payment. At the site 502 of the seller (e.g., client machine), a seller submits a request to print a shipping label (for example, from the marketplace application 120). A shipping API 504 calls a shipping vendor, such as Pitney Bowes, to get the label price. If the shipping API 504 gets a successful response, the shipping label price will be shown to the seller. If the shipping API 504 returns an error, the error message is shown to the seller. The seller can still cancel the transaction after viewing the label price.

If the seller decides to proceed with the shipping label after being shown the shipping label price, the seller can click on a “Pay and Print” button to purchase the label at 512. At 514, the system determines whether the seller has a signed billing agreement with the electronic marketplace 120. If the seller does not have a “Billing Agreement” with the electronic marketplace 120, the system will prompt the seller to login to a financial system (e.g. PayPal 516) to authorize payment for this transaction. If the authorization fails at 524, the system displays an error message at 520. If the authorization is successful at 524, PayPal 516 will redirect the seller back to the calling Site page. The calling Site page calls GetDetails to confirm the payment amount. PayPal 516 will pass the “reference” number to the shipping API 504. This reference number will also be passed later on to PayPal 516 for payment capture. The “reference” number associated with the shipping label can be stored in label database 522.

If seller has a “Billing Agreement” at 514, the system passes this “reference number” to PayPal 516 for payment capture.

At 518, the system calls Pitney Bowes to dispense the label for the address and label price. Pitney Bowes returns the label attributes to the electronic marketplace API 504 and the label database 522 is updated with those attributes.

Since the seller has not yet paid for the shipping label, the system will not display the label to the seller yet. Next, Label database 522 calls EMS 506 for Payment Capture.

EMS 506 creates the record with “Payment Request” status for this transaction and calls PGW 532 (of Payment Gateway 508) with the following attributes, in addition to others: Escrow ID, seller ID, eBay shipping account number for US Postal Service (USPS), billing reference number, and payment amount.

PGW 532 creates a new shipping wallet for the seller if the shipping wallet does not exist. PGW 532 calls PayPal 516 to capture payment using the merchant reference API at 536. In another embodiment, the electronic marketplace captures the one time payment with the USPS at 538. PayPal 516 processes the transaction and returns success/failure as follows:

In the case where the seller has a sufficient balance (stored value) in his/her PayPal account, PayPal 516 moves the payment amount from the seller's account to eBay's account and returns success.

In the case where the seller does not have a sufficient balance but has an instant funding source (credit card, debit card), PayPal 516 will attempt to authorize the seller's payment instrument (credit card, debit card). If the authorization is successful, PayPal 516 returns success. Note that in this case, the payment amount is not yet captured and may fail later (due to lack of funds) when PayPal 516 captures the payment). PayPal 516 moves the payment amount from the sellers' account to the eBay account and returns success. If the authorization fails, PayPal 516 returns failure.

PGW 532 updates the payment status and return transaction details to EMS 506 (Balance Manager 530). EMS 506 (Balance Manager 530) updates the Payment status and passes the payment status to label database 522.

If payment capture was successful at, the system displays the “shipping label” to the seller at 527. Otherwise, the system initiates a corporate refund and displays a Payment decline error message to the seller at 529. The Shipping Label will be voided as part of the corporate refund.

A PayPal Merchant TDR 534 (Daily Transaction Reconciliation Report) file is uploaded into PGW 532 for updating “Payment Acknowledgement” status. A Payment Merchant STL (Merchant Settlement Report) file is also updated into PGW 532 for updating “Payment Settlement” status.

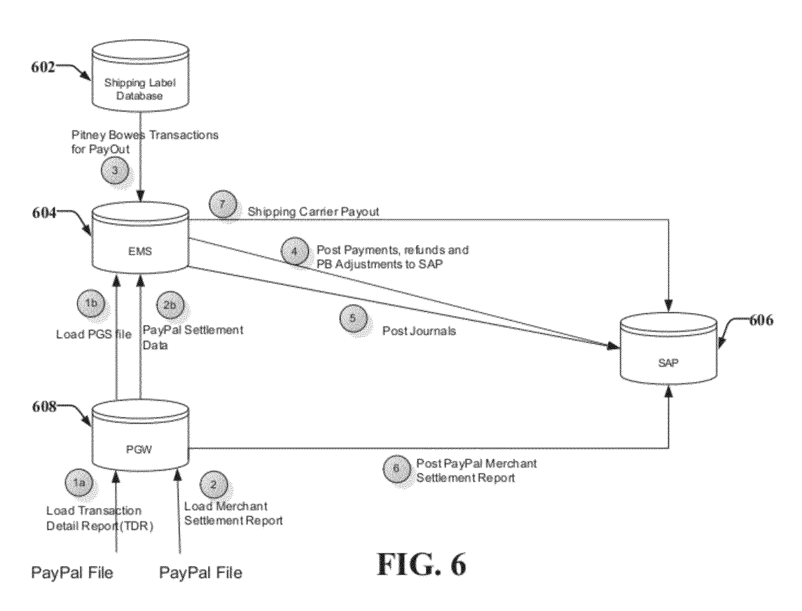

FIG. 6 is a block diagram illustrating an example embodiment of a process flow for a financial reconciliation. Financial systems such as PayPal upload TDRs and Merchant Settlement Reports to Payment Gateway PGW 608. PGW 608 summarizes and merges the TDR and Settlement report information and generates a Payment Gateway System (PGS) file. PGW 608 uploads the PGS file into EMS 604 to record transaction acknowledgement and cash settlement information from PayPal. EMS 604 also receives shipping vendor transactions (e.g. Pitney Bowes Transaction for Pay Out) from Shipping Vendor system 602.

EMS 604 then posts payments, refunds, and adjustments to the journaling system (e.g. SAP) 606. EMS 604 posts financial journal entries in SAP 606. PGW 608 posts PayPal merchant settlement reports to SAP 606. EMS posts Shipping Carrier Payouts to SAP 606.

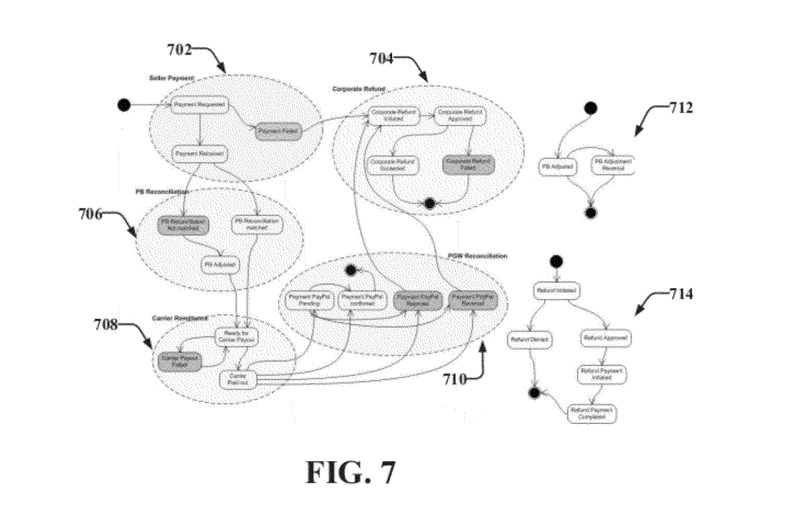

FIG. 7 is a block diagram illustrating an example embodiment of a transaction status transition diagram. An example of a payment flow starts with a seller requesting a payment at 702. If the payment fails, a corporate refund is initiated at 704. If the payment succeeds, the transaction is reconciled with the shipping vendor (PB stands for Pitney Bowes) at 706, and the carrier payout proceeds at Carrier remittance at 708. PGW Reconciliation 710 allows for payment gateways to be reconciled with the payment request transaction.

Flow diagram 712 illustrates an adjustment reversal process. Flow diagram 714 illustrates a refund process.

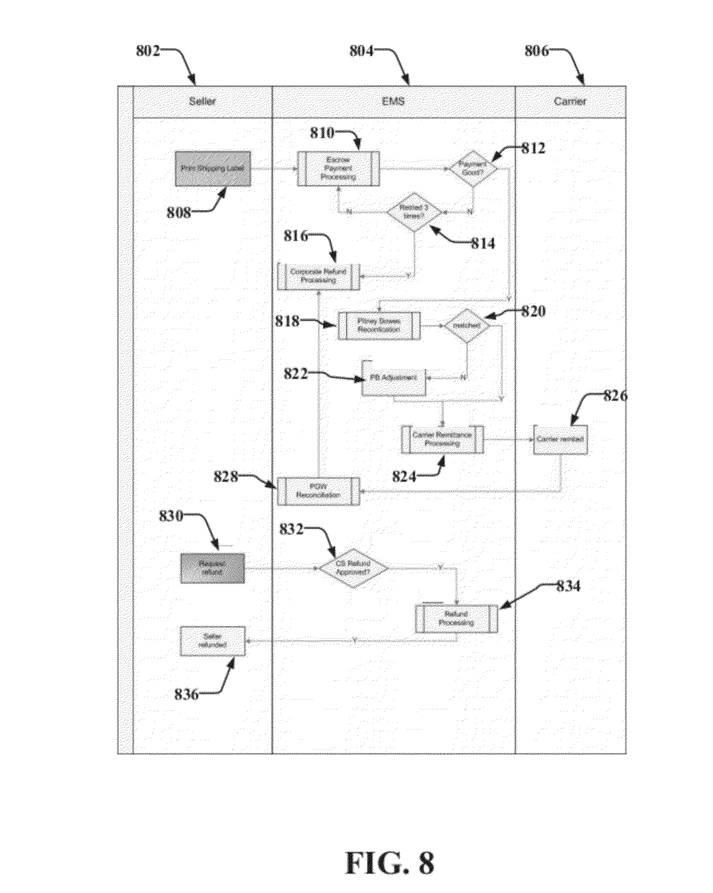

FIG. 8 is a flow diagram illustrating an example embodiment of a process for tracking payment between a seller 802, EMS 804, and Shipping vendor (e.g., Carrier 806). At 808, a seller requests to print a shipping label from the shipping vendor. At 810, EMS 804 proceeds with escrow payment processing of the request to determine whether the payment is good at 812 or whether to retry the payment at 814. If the payment is not successful, EMS 804 processes a corporate refund at 816 and reconciles with Payment Gateway at 828.

If the payment is successful, EMS 804 reconciles the transaction with the Shipping Vendor at 818. If the reconciliation matches at 820, the carrier remittance is processed at 824. Otherwise, the carrier issues an adjustment for the amount of the mismatched different at 822. The carrier 806 issues a remittance at 826, which is later reconciled with PGW at 828.

At 830, when a seller submits a request for a refund, the Customer Service associated with the EMS 804 or electronic marketplace determines whether to approve the refund at 832. If the refund is approved at 834, the seller is refunded at 836.

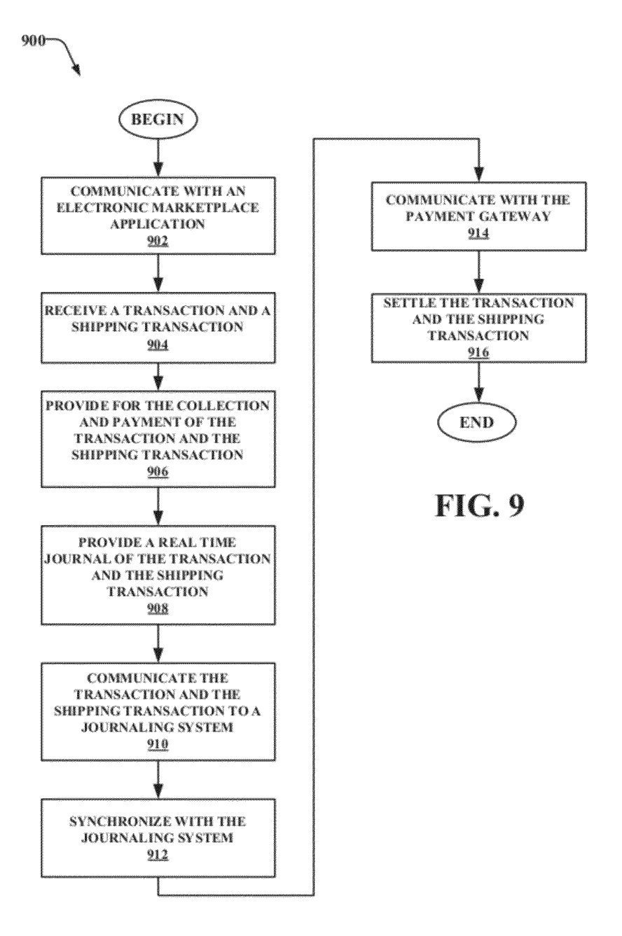

FIG. 9 is a flow chart 900 of one embodiment of a method for an escrow management system. At 902, the system (e.g. EMS 122) communicates with a seller and a buyer of a marketplace application with a client interface. At 904, the EMS 122 receives a transaction between the seller and the buyer from the marketplace application with a marketplace interface. Furthermore, the EMS may also receive a shipping transaction associated with the transaction of a shipping vendor of the marketplace with a vendor interface. At 906, the EMS provides collection and payment for the transaction and the shipping transaction in real time with a balance manager module. At 908, the EMS provides a real time journal of the transaction and the shipping transaction with the balance manager module. At 910, the EMS communicates the transaction and the shipping transaction to a financial journaling system with a journal interface. At 912, the EMS synchronizes with the financial journaling system without having to manually reconcile with the market application and the shipping vendor with the balance manager module. At 914, the EMS communicates with a payment gateway with a payment gateway interface, with the payment gateway configured to communicate with financial systems associated with the seller, buyer, and the shipping vendor. At 916 EMS settles the transaction and the shipping transaction with the financial journaling system as directed by the balance manager module.

In another embodiment, the EMS provides a shipping label for the shipping transaction based on a status of the shipping transaction based on the real time journal of the shipping transaction from the balance manager module with a shipping label module. The EMS further receives the shipping label at the vendor interface from the shipping vendor and voids the shipping label for the shipping transaction when the status of the shipping transaction includes a failed payment for the shipping label.

In another embodiment, the EMS stores the shipping label information in a shipping storage device coupled to the shipping label module. The EMS stores the real time journal of the transaction and the shipping transaction in a balance manager storage device coupled to the balance manager module. The EMS stores a payment failure or payment success for the transaction and the shipping transaction based on a communication with the payment gateway in a payment gateway storage device coupled to the payment gateway interface configured to store.

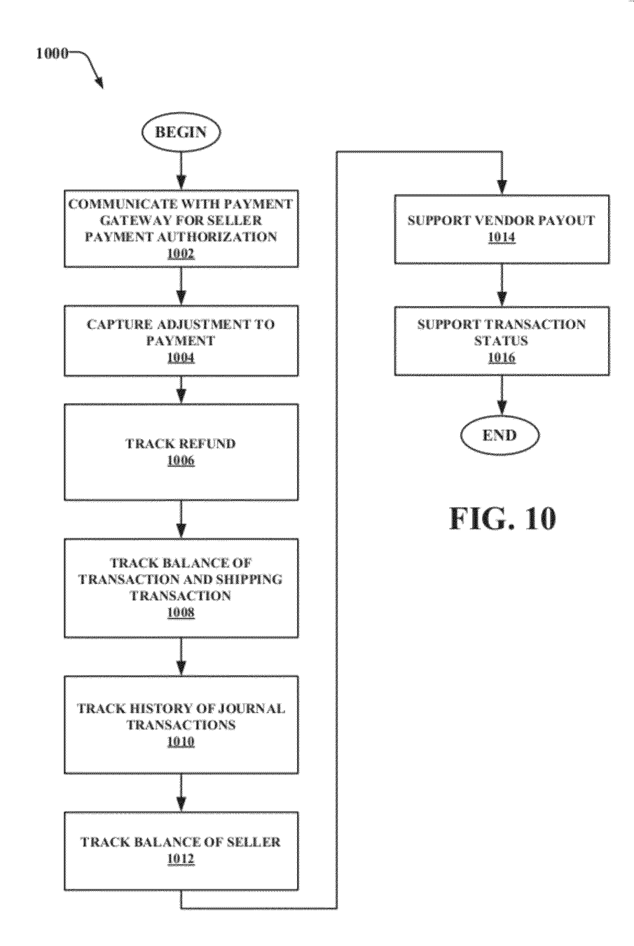

FIG. 10 is a flow chart 1000 of another embodiment of a method for an escrow management system. At 1002, the EMS communicates with the payment gateway interface for a seller payment authorization, a refund shipping label credit to the seller, and a shipping vendor payout with a payment gateway integration module. At 1004, the EMS captures an adjustment to the payment associated with the transaction and the shipping transaction with a payment adjustment module. At 1006, the EMS tracks a refund associated with the transaction and the shipping transaction with a refund module. At 1008, the EMS tracks a balance of the transaction and the shipping transaction with a transaction balance module. At 1010, the EMS tracks a history of journal transactions with a transaction history module. At 1012, the EMS tracks a balance of the seller with a seller balance module. At 1014, EMS supports a vendor payout with a vendor payout module. At 1016, the EMS supports transaction status comprising a payment, an adjustment, a refund, and a vendor payout with a transaction status module.

### Payment Distribution

With respect to FIG. 5, the shipping label database 522 captures the “Charge” amount along with other label-specific information. As part of capturing the seller's payment, the shipping label database 522 integrates with the EMS 506. In other words, the seller payment transaction for the charge is stored in EMS Balance Manager 530. However, the charge amount can be different from the payment amount (e.g. in case of eBay offering discounts to a seller from its own account). Hence, the charge is stored in shipping label database 522 and the payment is stored in the EMS balance manager 530. However, before the payment can be captured in the EMS balance manager 530, the shipping label database 522 needs to determine the entities involved in the transaction. The following are examples of some use cases:

Use Case 1: (Single Label Flow)
Payer—eBay Seller—$25 (One Label)
Payee—USPS—$25 (One Label)

Use Case 2: (Bulk Label Flow)
Payer—eBay Seller—$25
   Label id 1: $10
   Label id 2: $5
   Label id 3: $10
Payee—USPS—$25
   Label id 1: $10
   Label id 2: $5
   Label id 3: $10

Use Case 3: (International)
Payer—eBay Seller—$25
   Label id 1: $10
   Label id 2: $5
   Label id 3: $10
Payee 1—USPS—$20
   Label id 1: $8
   Label id 2: $4
   Label id 3: $8
Payee 2—eBay $5

Use Case 4:
Payer—eBay Seller—$25
Payee 1—USPS—$18
Payee 2—eBay—$5
Payee 3—Affiliate—$2

The shipping API 504 (also known as shipping label engine) needs to pass the payment distribution for payer and payee. The EMS 506 verifies that the payer amount equals to the amount of the sum distributed amongst the payee/s. If the amount does not match, the EMS 506 gives error messages about wrong payment distribution. In essence, a single payer payment can be distributed amongst multiple Payees.

In Shipping Label use case 1, the payer payment will be for single payee. However, in use case 2, one payment can be for multiple labels. The EMS 506 needs to store the label amount for the individual label as well as total payment to be authorized by PGW 532.

It should be noted that shipping label database 522 encapsulates the logic in shipping label database 522 for breakdown of payer payment among Payees and passes to the EMS Balance Manager 530 in order to store payment information and capture the payment through PGW 532.

Other applications that use the EMS 506 may only want to do real time payment authorization, and payment capture can be done off-line.

Shipping label engine 504 needs to pass the payment amount of the total charge amount that needs to be passed to PGW 508 for payment authorization. (e.g., the shipping label charge is for $10 and there is a $2 discount from eBay. Hence, in this case only $8 will be passed to PGW 532 for payment authorization. However, eBay owes $10 to Pitney Bowes). So, shipping label engine 504 needs to pass on the payment distribution with the payment to be captured as well as the remaining charge balance as a discount.

This is similar to the Half.Com business model, where a buyer has one shopping cart with items from multiple sellers. In this case, the buyer/Payer will make one payment. However, EMS 506 stores as many Payee records as the number of items in the cart. However, the sum total of the Payee payments should match the Payer amount. This is a Parent—Multiple child relationship between Payer and Payee for storing payment records. This will enable issuing refunds at the item level and capturing accurate information as mirrored in the shopping cart of the buyer.

### Payment Capture Data Elements

Shipping label database 522 calls the EMS Balance Manager 530 to capture the shipping label amount. Every request for capturing Payments passes the required fields for the EMS balance Manager 530. The shipping label database 522 passes the following information:

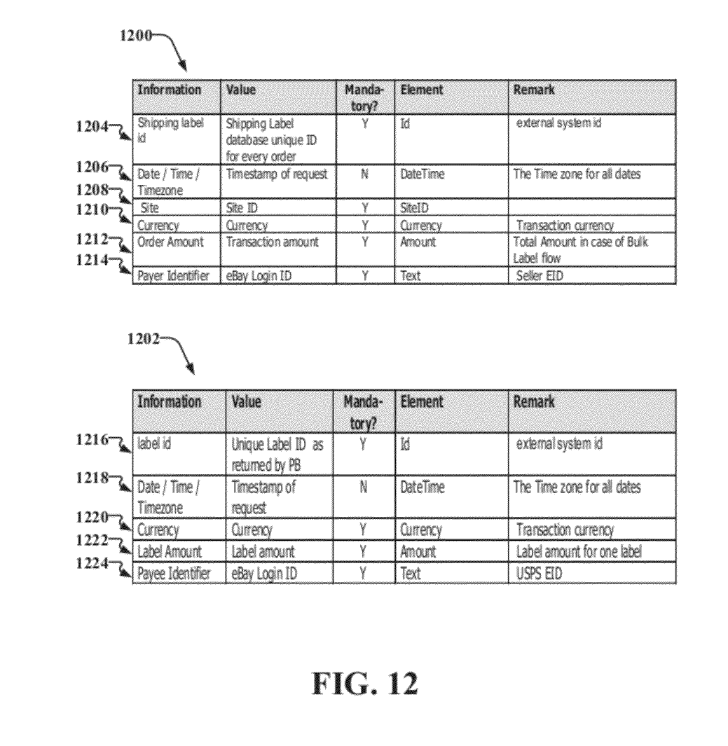

For one payer record, the information includes shipping label id 1204, data/time/timezone 1206, site 1208, currency 1210, order amount 1212, and payer identifier 1214, as illustrated in table 1200 of FIG. 12.

For one or more payee records, the information includes label id 1216, data/time/timezone 1218, currency 1220, label amount 1222, and payee identifier 1224 as illustrated in table 1202 of FIG. 12.

### Payment Capture

In one embodiment, the EMS balance manager 530 creates Payment record/s based on payment distribution with following attributes:
Transaction type: “Payment”
Transaction Status: “Payment Request”

The Balance Manager 530 creates the transactions for Payer and Payee with the transaction status of “Payment Request.” In essence, the Balance Manager 530 acts as a pass through for payment capture by passing relevant information to PGW 532 for Payment authorization and capture.

All requests by the shipping label engine 522 for payment capture will generate a unique escrow id. The Escrow id will be used to get information from PGW 532 and shipping label engine 504.

If there is an error in creating the payment record in the balance manager 530, the process flow stops and a “system error” is returned to the shipping label database 522.

If some mandatory data required for creating the payment record is missing, the process flow stops and a “system error” is passed to the shipping label database 522.

After a payment is recorded in the balance manager 530 with the status “Payment Request,” based on system processing, the transaction status can change to any of the following:
Payment Success—When PGW 532 returns “success” status after payment capture
Payment Failed—When PGW 532 returns “failed” status after payment capture
Payment Request—No response from PGW 532 (e.g., system timeout).
   Integration with Payment Gateway for Payment Processing

The EMS Balance Manager 530 integrates with PGW 532 to capture payment via a real time API call. All the relevant data needed for capturing payment is passed to the PGW 508 interface from the EMS 506. For example, for shipping labels, PGW 532 calls PayPal 516 to capture the funds. PGW 532 in turn submits the transaction request to PayPal 516 using a PayPal Merchant Services Reference Transaction API and processes the response. PGW 532 forwards the response to the EMS Balance Manager 530, which determines whether the transaction resulted in a “final” (success or failure—vs. timeout) state and performs actions based on that state.

PGW 532 then passes the payment capture status to the EMS 506. The payment status includes a payment success or a payment failure.

When PGW 532 returns “Payment Success” to the EMS 506, it means the payment amount requested by the EMS 506 has been successful. In this case, the EMS 506 will update the Payment Status from “Payment Request” to “Payment Approved” and store the PGW id associated with the Payment transaction. As a result of the payment success, eBay is expecting PayPal 516 to transfer funds from seller PayPal account to the eBay Merchant account as specified in the call to PGW 508 and PayPal 516. With the shipping label payment authorization, a purchase amount is automatically deducted from a seller PayPal account, after the seller has agreed to pay for the shipping label.

When PGW 532 returns “Payment Failure” to the EMS 506, it means the payment authorization has FAILED for the payment amount requested by the EMS 506. In this case, the EMS 506 will update the Payment Status from “Payment Request” to “Payment Failed” and store the PGW id associated with the Payment transaction.

After the EMS 506 has updated the payment status, the label database 522 will passed on the payment status for dispensing the label or displaying an error message to user. If the payment authorization fails, the shipping label database 522 will initiate a corporate refund to the shipping vendor (e.g. Pitney Bowes).

If the EMS 506 does not get any response from PGW 532 within a specified time limit, the system flow times out and the user shows an error message to the seller with the shipping label calling API 504. At this time, the EMS 506 has the payment status of “Payment Request” and the status remains “Payment Request.”

After PGW 532 receives the TRD and Merchant Settlement files from PayPal, PGW 532 will generate a PGS file and load this to EMS 506. If the payment transaction is passed in the TDR, EMS 506 will update the Payment Status from “Payment Approved” to “Payment Reconciled”. If the payment transaction is passed in the Merchant Settlement report, EMS 506 will update the Payment Status from “Payment Reconciled” to “Payment Settled”. This status indicates that cash payment has been successfully received for the transaction.

Integration with Shipping Label Database for Payment Adjustment

Shipping label database 522 calls the EMS Balance Manager 530 to create payment adjustments. Payment adjustments may be needed because of a difference in the amount captured by the EMS 506 and Pitney Bowes 518 or PayPal 516. In case there is difference of amount between the EMS 506 and Pitney Bowes 518 or PayPal 516, adjustment transactions are created for the payment that needs the adjustment.

Payment adjustments are created with following data elements: Two records, with one for the Payer and the other for the Payee.:
Transaction type=“Adjustment”
Transaction status=“Adj Created”
Adjustment amount
Reason code

The adjustment record cannot be created on its own and needs to reference the existing record of transaction type “Payment.”

For example, if the EMS 506 has a payment record of $5 for a shipping label, and Pitney Bowes reports $6 for the same shipping label, then Pitney Bowes 518 will create an adjustment record for the difference in amount. This is how the adjustment will appear in the EMS 506:
Payer—eBay Seller—$25 (Trx type: Payment, Status=“Payment Success”)
Payee—USPS—$26
   Label id 1: $1 (Trx type: “Adjustment,” Status=“Adjustment Created,” PB)
   Label id 1: $1 (Trx type: “Adjustment,” Status=“Adjustment Created,” EBay)

It should be noted that the payment amount of the transaction type of “Payment” is not updated. If there is any need to record the difference in payment amount, an “Adjustment” transaction is created. Refunds and Reversal transactions are not adjustment transactions.

Adjustments are created as part of the PB reconciliation process. As per vendor payout flow, the EMS 506 pays the PB invoiced amount based on approval. There is no process defined for approving/denying adjustments. Hence, all adjustments in “Approved” status are created. The sum of the adjustment amount is sent as part of the USPS payment amount.

Payment adjustments records needs to be created in EMS 506 before they can be paid out to the vendor and recorded into SAP 212. After the creation of an adjustment record, the transaction status of the adjustment is “Adjustment approved.” Transactions with “Adjustment approved” status are eligible for Vendor Payout.

The following is an example of an adjustment approved use case:
1. EMS 506 has a shipping label of $5.
2. Pitney Bowes 518 reports $5.50 for the same label.
3. PB 818 reconciliation process creates an adjustment transaction of $0.50 within the Shipping Database and EMS 506.
4. Adjustment transactions in EMS 506 are set to “Adjustment Approved” since there is an obligation to pay this PB invoiced amount.
5. Adjustment transactions are captured as part of the PB invoiced amount that is paid out.

Payment adjustments can be denied before they can be paid out to the vendor and recorded into SAP 212. After an adjustment is denied, the transaction status of the adjustment changes to “Adjustment denied.” Transactions with “Adjustment denied” status are not eligible for Vendor Payout.

The following is an example of an adjustment denied use case:
1. EMS 506 has a shipping label of $5.
2. Pitney Bowes 518 reports $11 for the same label.
3. PB 818 reconciliation process will create an adjustment transaction of $6.
4. Shipping BU/Finance will reject the adjustment since there is a significant difference in amount. This adjustment will not be paid out.

### Refund Transactions

The EMS Balance Manager 530 supports the ability to create refunds collections. Prior to EMS paying a refund back to the eBay seller, it will attempt to collect the refund amount from the label carrier.

Refund Collections are created with the following data elements:
Transaction Type=“Refunds”
Transaction Status=“Refund Collection”
Refund amount

Refund Collections: refund collections are initiated from the shipping label database, to request a refund from the label carrier. Based upon business rules, the shipping database will receive notification via the reconciliation file of whether the refund collection has been approved or not by the label carrier.

The label carrier determines whether the label is approved or not, using certain business rules such as whether the label has been used within a define period of time.

When a refund is approved, transactions in EMS 530 are marked as “Refund Collection Approved”. EMS 530 will automatically initiate a refund payment to be made to the eBay seller.

When a refund is denied by the label carrier, EMS 530 will mark transactions as “Refund Collection Rejected”. EMS 530 will not automatically initiated a refund payment to the eBay seller. Labels that are denied a refund from the label carrier can only be refund if the eBay seller contacts CS to make a formal request for a courtesy refund. Courtesy refunds are issued based on business rules.

The EMS Balance Manager 530 supports the ability to create payment refunds. Payment refunds to the eBay seller may be needed because of several reasons (e.g., one time courtesy credit, difficulty in printing label, unused shipping label etc.).

Payment refunds are created with following data elements:
Transaction type=“Refund”
Transaction status=“Refund Payment”
Refund amount
Reason code

Shipping rules define business rules associated with different types of refunds (e.g. Corporate refunds, seller-initiated label voids from site, customer service initiated label voids from site, customer service courtesy refunds). In the above scenarios, the shipping label engine will pass the refund distribution to the EMS 506, upon which the entity will get the refund (e.g., eBay in case of corporate refund and the seller in case of void/CS refund).

Following are the high-level use cases of refunds for shipping label implementation:
Corporate Refund Payment: a corporate refund is the type of refund initiated from the shipping label database after a dispense request from PB was success but the payment from the seller failed or there was a timeout getting a response from PGW to EMS. The shipping label database will initiate the corporate refund. In this case, the shipping API will call PB for the refunding label amount, and the label will be marked as void. Pitney Bowes will send the corporate refunds in the daily transaction file.
CS initiated/User initiated Site Refund Payment: users who decide not to use the printed postage have the ability to void their un-used label and request a refund. A user can request a label refund from “My eBay” or call CS to help them get the refund. The business rules define if the user's refund will be approved or not.
Bulk Refund Payment: the system has the ability to perform bulk refunds in case the normal flow fails or in case of a system failure and eBay needs to issue refunds to a large number of sellers.
   CS Courtesy Payment: users can call CS about their label. Based on business rules, CS may issue a courtesy refund to pay back the user for the label.
   Instant Refund Payment: users can call CS about a label they have previously voided. Based on business rules, CS may issue an instant refund, to pay the user in advance for the label refund amount.

A refund payment record cannot be created on its own and needs to reference an existing record of transaction type “Payment.” Refund payments are created with the transaction status=“Refund Payment Requested.” Only after the refund is approved will the refund amount be credited to the eBay seller.

The payment amount of the transaction type of “Payment” is not updated. If there is any need to refund payment amount, a “Refund Payment” transaction is created.

Refunds are not “adjustment” transactions. The system allows for partial/full refund. Refunds are always created at the shipping label/item and not at the order/cart level. Refunds are not to be created at the order/cart level. Also, the refund amount for shipping cannot exceed the payment amount of that label. The refund amount available is maintained at the shipping label/item level.

For example, if EMS has a payment record of $25 for a shipping label and a user requested a refund, this is how the refund will appear in the EMS:
Payer—eBay Seller—$25 (Trx type: Payment, Status=“Payment Success”)
Payee—USPS—$25
   Label id 1: $25
   Label id 1: $1 (Trx type: “Refund,” Status=“Refund Payment Requested,” eBay Seller)
   Label id 1: $1 (Trx type: “Refund,” Status=“Refund Payment Requested,” EBay)

### Reversal/Chargeback Transactions

The EMS Balance Manager 530 supports the ability to create payment reversals. Payment reversals are needed because of several reasons (e.g., insufficient funds in credit card or debit card, seller requests PayPal Customer Service to dispute the transaction, or seller requests a credit card/debit card company to dispute the transaction):
1. A seller can only request a chargeback/reversal on a prior Escrow transaction that has been paid and settled.
2. Chargebacks can be for either a partial or full return of money to the seller on a prior transaction. This may occur when the seller approaches their credit card or debit card issuing bank to dispute the label payment. This occurs outside of the Shipping label refund request process.
3. Like the case with refunds, there are multiple partial chargebacks (for individual labels) since the escrow cart ID and the final PGW ID for the successful payment remains the same for all the labels printed in the same order.
4. Once a chargeback is requested, the money is deducted from the Shipping PayPal account, and refund back to the eBay seller's PayPal account.
5. PayPal will report the event via the Merchant Settlement report file to indicate that cash has been refunded to the seller.
6. When the Merchant Settlement report is loaded to EMS 530, a “Payment Reversal Acknowledgement” will be created.
7. Since partial chargeback is supported, error checks are implemented to ensure that the chargeback amount does not exceed the available balance amount (amount left over after all past refunds and/or chargebacks).

### Discount Transactions

The EMS Balance Manager 530 supports the ability to create payment discounts. Discount transactions are needed in order to support promotions. Promotions are a way to entice customers to use the shipping label service.

### Vendor Payout

If a transaction of type “Payment,” “Adjustment” and/or “Refund” within the EMS 506 has the status “Outbound Payment Requested,” the EMS 506 generates a summary file to pay to the Shipping Carrier. All the records marked for payment are assigned a unique vendor summary payout id. The batch job aggregates the entire amount from all the marked records and creates a summary record in the Vendor Payout table. After all the records are marked for payment, the EMS 506 changes the record status to “Outbound Payment Approved” to indicate payment request is made.

The EMS 506 sends the shipping carrier disbursement to PGW 508. This disbursement can be done by an API or a batch program. In one embodiment, there is one disbursement per day. The disbursement is from “eBay Merchant account for shipping carrier at PayPal” to “USPS PayPal or Bank account.” If the disbursement fails, PGW 508 passes the acknowledgement to the EMS 506 and the EMS 506 changes the status of transactions from “Paid” to “Payout Failed.”

EMS 530 can make outbound payment requests to pay one or multiple vendors at the same time.

### Tracking Transaction Balance

The ability to track transaction balance is important to the EMS 506. All transactions in the EMS 506 start with a “Payment,” but over a period of time can have adjustments, refunds, chargebacks and discounts associated to them. A transaction balance can be derived after taking into account all the associated transactions.

Payment and discount is at the transaction level and makes it equal to charge. Any transaction after that (from numbers 3 to 9 in FIG. 5) is related to seller level transaction.

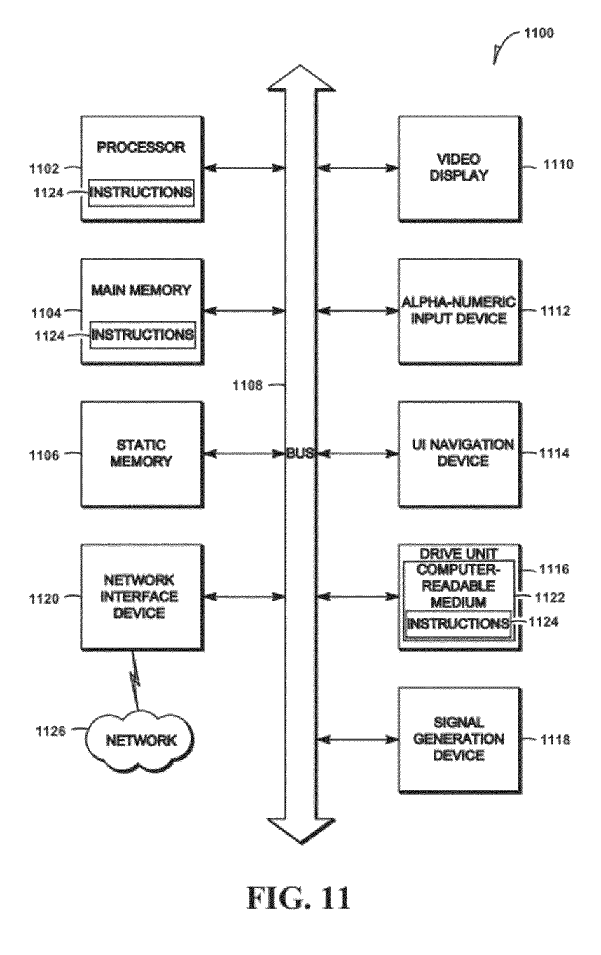

FIG. 11 shows a diagrammatic representation of a machine in the example form of a computer system 1100 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation device 1114 (e.g., a mouse), a disk drive unit 1116, a signal generation device 1118 (e.g., a speaker) and a network interface device 1120.

The disk drive unit 1116 includes a machine-readable medium 1122 on which is stored one or more sets of instructions and data structures (e.g., software 1124) embodying or utilized by any one or more of the methodologies or functions described herein. The software 1124 may also reside, completely or at least partially, within the main memory 1104 and/or within the processor 1102 during execution thereof by the computer system 1100, with the main memory 1104 and the processor 1102 also constituting machine-readable media.

The software 1124 may further be transmitted or received over a network 1126 via the network interface device 1120 utilizing any one of a number of well-known transfer protocols (e.g., HTTP).

While the machine-readable medium 1122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An escrow management system comprising:
a client interface configured to communicate with a computing device of a seller and a computing device of a buyer, the buyer and seller participants in a transaction via an online marketplace application;
a marketplace interface configured to receive a transaction information between the seller and the buyer from the online marketplace application;
a vendor interface configured to receive a shipping transaction information associated with the transaction of a shipping vendor of the marketplace;
a journal interface configured to communicate the transaction information and the shipping transaction information to a financial journaling system;
a balance manager module configured to provide collection and payment for the transaction and the shipping transaction in real time, to provide a real time journal of the transaction and the shipping transaction, to synchronize with the financial journaling system without having to manually reconcile with the online market application and the shipping vendor; and
a payment gateway interface configured to communicate with a payment gateway, the payment gateway configured to communicate with financial systems associated with the seller, buyer, and the shipping vendor, and to settle the transaction and the shipping transaction with the financial journaling system as directed by the balance manager module, the balance manager module providing an integrated system to track cash flows related to the collection and payment corresponding to the transaction and shipping transaction.

2. The escrow management system of claim 1, further comprising:
a shipping label module configured to provide a shipping label for the shipping transaction based on a status of the shipping transaction based on the real time journal of the shipping transaction received from the balance manager module, the shipping label received at the vendor interface from the shipping vendor, the shipping label module configured to void the shipping label for the shipping transaction when the status of the shipping transaction includes a failed payment for the shipping label.

3. The escrow management system of claim 2, further comprising:
a shipping storage device coupled to the shipping label module, the shipping storage device configured to store shipping label information;
a balance manager storage device coupled to the balance manager module, the balance manager storage device configured to store the real time journal of the transaction and the shipping transaction; and
a payment gateway storage device coupled to the payment gateway interface configured to store a payment status indicating the success or failure of the payment for both inbound and outbound payment transactions and the shipping transaction based on a communication with the payment gateway.

4. The escrow management system of claim 1, wherein the balance manager module comprises:
a payment gateway integration module configured to communicate with the payment gateway interface for a seller payment authorization, a refund shipping label credit to the seller, and a shipping vendor payout;
a payment adjustment module configured to capture an adjustment to the payment associated with the transaction and the shipping transaction;
a refund module configured to track refund collections and refund payments associated with the transaction and the shipping transaction;
a transaction balance module configured to track a balance of the transaction and the shipping transaction;
a transaction history module configured to track a history of journal transactions;
a seller balance module configured to track a balance of the seller;
a vendor payout module configured to support a vendor payout; and
a transaction status module configured to support transaction status comprising a payment, an adjustment, a refund, and a vendor payout.

5. The escrow management system of claim 1, wherein the payment gateway communicates with one or more financial systems associated with the buyer and the seller and reconciles financial transactions with the balance manager module.

6. The escrow management system of claim 1, wherein the balance manager module is configured to generate an exception report.

7. The escrow management system of claim 1, wherein the transaction comprises a buyer protection insurance purchase and the shipping transaction comprises a shipping label purchase or a shipping insurance purchase.

8. A computer-implemented method comprising:
communicating with a computing device of a seller and a computing device of a buyer, the buyer and seller participants in a transaction via an online marketplace application with a client interface;
receiving a transaction information between the seller and the buyer from the online marketplace application with a marketplace interface;
receiving a shipping transaction information associated with the transaction of a shipping vendor of the marketplace with a vendor interface;
providing collection and payment for the transaction and the shipping transaction in real time with a balance manager module;
providing a real time journal of the transaction and the shipping transaction with the balance manager module;
communicating the transaction information and the shipping transaction information to a financial journaling system with a journal interface;
synchronizing with the financial journaling system without having to manually reconcile with the online market application and the shipping vendor with the balance manager module;
communicating with a payment gateway with a payment gateway interface, the payment gateway configured to communicate with financial systems associated with the seller, buyer, and the shipping vendor; and
settling the transaction and the shipping transaction with the financial journaling system as directed by the balance manager module, the balance manager module providing an integrated system to track cash flows related to the collection and payment corresponding to the transaction and shipping transaction.

9. The computer-implemented method of claim 8, further comprising:
providing a shipping label for the shipping transaction based on a status of the shipping transaction based on the real time journal of the shipping transaction received from the balance manager module with a shipping label module;
receiving the shipping label at the vendor interface from the shipping vendor; and
voiding the shipping label for the shipping transaction when the status of the shipping transaction includes a failed payment for the shipping label.

10. The computer-implemented method of claim 9 further comprising:
storing shipping label information in a shipping storage device coupled to the shipping label module;
storing the real time journal of the transaction and the shipping transaction in a balance manager storage device coupled to the balance manager module; and
storing a status indicating the success or failure of the payment for the transaction and the shipping transaction based on a communication with the payment gateway in a payment gateway storage device coupled to the payment gateway interface.

11. The computer-implemented method of claim 8, wherein the balance manager module is configured to:
communicate with the payment gateway interface for a seller payment authorization, a refund shipping label credit to the seller, and a shipping vendor payout with a payment gateway integration module;
capture an adjustment to the payment associated with the transaction and the shipping transaction with a payment adjustment module;
track a refund associated with the transaction and the shipping transaction with a refund module;
track a balance of the transaction and the shipping transaction with a transaction balance module;
track a history of journal transactions with a transaction history module;
track a balance of the seller with a seller balance module;
support a vendor payout with a vendor payout module; and
support transaction status comprising a payment, an adjustment, a refund, and a vendor payout with a transaction status module.

12. The computer-implemented method of claim 8, wherein the payment gateway communicates with one or more financial systems associated with the buyer and the seller and reconciles financial transactions with the balance manager module.

13. The computer-implemented method of claim 8, wherein the balance manager module is configured to generate an exception report.

14. The computer-implemented method of claim 8, wherein the transaction comprises a buyer protection insurance purchase and the shipping transaction comprises a shipping label purchase or a shipping insurance purchase.

15. A non-transitory computer-readable storage medium storing a set of instructions that, when executed by a processor, cause the processor to perform operations, comprising:
communicating with a computing device of a seller and a computing device of a buyer, the buyer and seller participants in a transaction via an online marketplace application with a client interface;
receiving a transaction information between the seller and the buyer from the online marketplace application with a marketplace interface;
receiving a shipping transaction information associated with the transaction of a shipping vendor of the marketplace with a vendor interface;
providing collection and payment for the transaction and the shipping transaction in real time with a balance manager module;
providing a real time journal of the transaction and the shipping transaction with the balance manager module;
communicating the transaction information and the shipping transaction information to a financial journaling system with a journal interface;
synchronizing with the financial journaling system without having to manually reconcile with the online market application and the shipping vendor with the balance manager module;
communicating with a payment gateway with a payment gateway interface, the payment gateway configured to communicate with financial systems associated with the seller, buyer, and the shipping vendor; and
settling the transaction and the shipping transaction with the financial journaling system as directed by the balance manager module, the balance manager module providing an integrated system to track cash flows related to the collection and payment corresponding to the transaction and shipping transaction.

16. The non-transitory computer-readable storage medium of claim 15, further comprising:
providing a shipping label for the shipping transaction based on a status of the shipping transaction based on the real time journal of the shipping transaction from the balance manager module with a shipping label module;
receiving the shipping label at the vendor interface from the shipping vendor; and
voiding the shipping label for the shipping transaction when the status of the shipping transaction includes a failed payment for the shipping label.

17. The non-transitory computer-readable storage medium of claim 16, further comprising:
storing shipping label information in a shipping storage device coupled to the shipping label module;
storing the real time journal of the transaction and the shipping transaction in a balance manager storage device coupled to the balance manager module; and
storing a status indicating the success or failure of the payment for the transaction and the shipping transaction based on a communication with the payment gateway in a payment gateway storage device coupled to the payment gateway interface.

18. The non-transitory computer-readable storage medium of claim 15, wherein the balance manager module is configured to:
communicate with the payment gateway interface for a seller payment authorization, a refund shipping label credit to the seller, and a shipping vendor payout with a payment gateway integration module;
capture an adjustment to the payment associated with the transaction and the shipping transaction with a payment adjustment module;
track a refund associated with the transaction and the shipping transaction with a refund module;
track a balance of the transaction and the shipping transaction with a transaction balance module;
track a history of journal transactions with a transaction history module;
track a balance of the seller with a seller balance module;
support a vendor payout with a vendor payout module; and
support transaction status comprising a payment, an adjustment, a refund, and a vendor payout with a transaction status module.

19. The non-transitory computer-readable storage medium of claim 15, wherein the payment gateway communicates with one or more financial systems associated with the buyer and the seller and reconciles financial transactions with the balance manager module.

20. The non-transitory computer-readable storage medium of claim 15, wherein the balance manager module is configured to generate an exception report, wherein the transaction comprises a buyer protection insurance purchase and the shipping transaction comprises a shipping label purchase or a shipping insurance purchase.
